(19) United States
(12) Patent Application Publication
(10) Pub. No.: US 2014/0272090 A1
(43) Pub. Date: Sep. 18, 2014

(54) ANIMAL SNACK PRODUCTS AND PROCESSES

(71) Applicant: Joe Crump, Caledon East (CA)

(72) Inventor: Joe Crump, Caledon East (CA)

(21) Appl. No.: 13/838,028

(22) Filed: Mar. 15, 2013

(51) Int. Cl. A23K 1/14

(52) U.S. Cl. CPC A23K 1/143
USPC 426/635

(57) ABSTRACT

An animal snack product and processes for making animal snack products is provided. A process includes baking at least one sweet potato to reach a conversion temperature for a time sufficient to generally uniformly convert starch in the at least one sweet potato to sugar; forming a thickened mash from the at least one sweet potato; forming segments of desired shape and thickness from the thickened mash; and applying heat at a drying temperature that is below the burning point of the sugar for a time sufficient to dry the segments to a threshold moisture level.

### FIELD OF THE INVENTION

The present invention relates generally to animal snack products and specifically to an animal snack product made from sweet potato and processes for making animal snack products.

### BACKGROUND OF THE INVENTION

Dogs and other animals enjoy snacking on tough objects. Accordingly, a great deal of research and development has been directed at producing animal snack products for consumer and veterinary markets that are desirable to animals and/or promote the animals' health.

U.S. Pat. No. 4,892,748 to Anderson et al. discloses a low calorie pet treat composed of food grade cellulose, a unique binder system, colour and salt ingredients melded together into a desired shape.

U.S. Pat. No. 5,431,927 to Hand et al. discloses a pet food product prepared from a fibre containing nutritionally balanced mixture of carbohydrate protein, fat, vitamins and minerals exhibiting a mechanical tooth cleansing function for reduction of plaque.

U.S. Pat. No. 5,501,868 to Collings et al. discloses an extruded dog treat food product having improved resistance to breakage.

U.S. Pat. No. 5,500,239 to Hayward discloses a method and apparatus for the manufacture of a pet food product having a fibrous striated structural matrix.

U.S. Pat. No. 6,126,978 to Axelrod discloses an edible dog chew comprised of injection molded potato starch, calcium carbonate and a fruit flavouring, food coloring or breath sweetener.

U.S. Pat. No. 6,060,100 to Koller discloses a pet chew treat made from the gastro-intestinal organs of a bison.

U.S. Pat. No. 6,228,418 to Gluck et al. discloses a pet treat made with corn flour and a palatability enhancer such as vegetable digest, liver digest, poultry digest, beef digest, and other ingredients.

PCT Patent Application Publication No. WO 2012/052425 to Lund et al. discloses a chewable product for humans or animals having improved chew resistance due to the incorporation of hydrocolloids, sweeteners and humectants within a carbohydrate mix.

While extruded and injection-molded products made from combinations of various ingredients including sweeteners and flavourings are known, improvements in processes for making snack products having primarily natural ingredients are increasingly desirable.

U.S. Pat. No. 7,537,794 to Baldus discloses a digestible animal chew made from a dehydrated sweet potato. The animal chew is described as non-allergenic and as having a striated, deeply furrowed surface to improve the oral hygiene of the animal. The animal chew also described as low in calories, high in vitamins, minerals and fibre and as containing no animal-based or synthetic products. The process by which the animal chew is made also disclosed in the patent, and generally includes steps of segmenting, blanching and dehydrating the sweet potato.

U.S. Pat. No. 4,632,834 to Barnes discloses a frozen sweet potato product and process for its production. The process involves slicing unpeeled sweet potatoes in a direction perpendicular to their longitudinal axes, blanching the slices for 1 to 1.5 minutes in water of about 200° Fahrenheit (F), cooling the blanched slices and applying orange juice to the slices prior to quick freezing.

U.S. Pat. No. 5,118,518 to Hattori et al. discloses a method for manufacturing very thin, dried sweet potato chips having a thickness on the order of 1 mm or less. The method includes heating raw sweet potatoes at a temperature ranging from 70° Celsius (C) to 100° C. to adjust hardness of the sweet potatoes to 1,800 to 12,000 and then slicing the heated sweet potatoes to a desired thickness. This primary heat treatment is purported to enhance the activity of β-amylase present in the sweet potato to increase the amount of maltose produced and thereby sufficiently bring out the sweetness of the sweet potato while permitting slicing into thin slices on the order of 0.3 to 1 mm. The patent indicates that the primary heat treatment is preferably carried out by hot water immersion and steam cooking techniques. A second heat treatment is conducted after the slicing to convert starches present in the sweet potato to a-starches (gelatinized starches).

U.S. Pat. No. 6,601,539 to Snook discloses a vegetable based animal chew, animal chew toy, and method of making the same comprising cutting a vegetable such as a sweet potato into slices, removing a cylindrical core from the slices, dehydrating the slices, and arranging the dehydrated slices on a cord.

U.S. Pat. No. 2,769,714 to Stahmer discloses cooked sliced potato products having one side of a corrugated configuration and the other side of a flat configuration, and a method for making the potato product.

Various processes exist for dehydrating vegetable products for packaging, freezing and later rehydration, or for otherwise preparing the vegetable products. For example, U.S. Pat. No. 871,962 to Cooke discloses a process of dehydrating animal and vegetable substances.

U.S. Pat. No. 3,295,995 to Bright et al. discloses a process of dehydrating vegetables.

U.S. Pat. No. 3,794,500 to Lazar et al. discloses a process by which inner core enzymes in a fruit or vegetable product may be deactivated through blanching.

French Patent Application Publication No. 2,769,472 discloses recipes for producing thinly sliced fruits or vegetables.

U.S. Pat. No. 6,468,573 to Herrick et al. discloses a process for making rehydratable food pieces using impingement drying.

While various animal snack products and food preparation processes are known, improvements are desirable for providing sweet-tasting, tough and nutritious animal snack products from sweet potatoes.

### SUMMARY OF THE INVENTION

According to an aspect, there is provided a process for making animal snack products, comprising baking at least one sweet potato to reach a conversion temperature for a time sufficient to generally uniformly convert starch in the at least one sweet potato to sugar; forming a thickened mash from the at least one sweet potato; forming segments from the thickened mash; and applying heat at a drying temperature that is below the burning point of the sugar for a time sufficient to dry the segments to a threshold moisture level.

In an embodiment, the segments are formed as strips.

In an embodiment, during the baking substantially all of the starch in the sweet potato is converted to sugar.

According to another aspect, there is provided a process for making animal snack products, comprising baking at least one sweet potato to reach an internal temperature of about 170° F. to about 210° for a time sufficient for the flesh in the sweet potato to significantly soften while retaining its structure; forming a thickened mash from the at least one sweet potato; forming segments from the thickened mash; and applying heat at a drying temperature that is below the burning point of the sugar for a time sufficient to dry the segments to a threshold moisture level.

In an embodiment, the threshold moisture level is about 8% to about 20%.

According to another aspect, there is provided a process for making animal snack products, comprising baking at least one sweet potato to reach a conversion temperature for a time sufficient to generally uniformly convert starch in the at least one sweet potato to sugar while retaining sufficient structure in the at least one sweet potato; forming a thickened mash from the at least one sweet potato; forming segments from the thickened mash; and applying heat at a drying temperature that is below the burning point of the sugar for a time sufficient to dry the segments to a threshold moisture level.

According to another aspect, there are provided animal snack products made according to the above-described processes.

### BRIEF DESCRIPTION OF THE DRAWINGS

Embodiments of the invention will now be described with reference to the appended drawings in which:

FIG. 1 is a flow diagram of a process for making animal snack products according to an embodiment;

FIG. 2 is a flow diagram showing further detail of the baking; and

FIG. 3 is a flow diagram showing further detail of the drying.

### DETAILED DESCRIPTION

Turning now to FIG. 1, a process for making sweet-tasting, tough and nutritious animal snack products from sweet potatoes is shown generally at 10. During the process, raw sweet potatoes, having been previously washed to remove dirt and other contaminants, are baked whole with skin and all, to reach a conversion temperature for a time sufficient to generally uniformly convert starch in the at least one sweet potato to sugar (step 100). A thickened mash is then formed from the baked sweet potatoes (step 200). Segments are then formed from the thickened mash (step 300). Heat is then applied at a drying temperature that is below the burning point of the sugar for a time sufficient to dry the segments to a threshold moisture level (step 400).

It is preferred that orange-fleshed sweet potatoes, such as Beauregard, Covington, Jewels, Garnet, Morning Glory, Redskin and Evangeline varieties be processed according to the invention. However, the process may be applied to other varieties of sweet potato.

FIG. 2 is a flow diagram showing further detail of the baking. It is desirable to strike a balance between maximizing sweetness of the animal snack being made and limiting the amount of moisture produced in the baking step.

Slicing sweet potatoes into segments prior to baking results in exposure of the inner flesh of the sweet potatoes directly to the external heat being applied. The heat permeating the exposed flesh directly immediately converts starches in the surface of the flesh to sugars, but continued application of the heat to permeate to the inner flesh can result in burning of the sugars in the surface before the underlying flesh can be exposed to a suitable amount of heat for its respective starch to sugar conversion. It is undesirable to burn the sugars as it negatively affects the taste of the animal snack.

It has been found that desirable starch to sugar conversion without undue burning of the resultant sugar can be done by baking the whole sweet potato, with skin, prior to forming the thickened mash. The skin itself contains nutrients, and the mash can be thickened more easily by including the skin.

Furthermore, without wishing to be bound to a particular theory, it is believed that, within certain temperature ranges, the skin distributes heat in a way to reduce the rate at which the sugar conversion at the outermost flesh occurs. As such, conversion of sugars in the sweet potato occurs more uniformly, lessening or eliminating the burning of resultant sugars. However, it has also been found that baking for too long while attempting to assure absolute maximum sweetness can bring about the problem of excess moisture that must be extracted later in the process.

For animal snack products such as are described herein, it is desirable to retain sufficient structure in the sweet potatoes after baking as a signal that the potatoes have not become overly moist.

The present inventor has found that a suitable balance between sweetness and texture desired for a thickened mash after baking is achieved by baking sweet potatoes whole, with skin, at an oven temperature of about 380° F. to about 420° F. for about 80 to about 100 minutes, using a convection oven. It has been found that baking the orange-fleshed sweet potatoes at about 400° F. for about 90 minutes with this type of oven causes the sweet potatoes to have a uniform, deep-orange flesh that is suitably sweet and not overly moist.

The cooking time will vary depending on the batch size.

It will be understood that there are a large range of different ovens that could be used, and each may exhibit different capabilities, heating times and temperature variability within their interiors. It is preferred that the oven be controlled to produce heat such that the core temperature of the sweet potatoes reaches a conversion temperature of about 170° F. to about 210° F., and more preferably about 180° F. to about 200° F., and even more preferably about 190° F. It will be appreciated that greater consistency in the sweetness, texture and appearance of the animal snack products are achieved when the range of core temperatures across sweet potatoes is smaller.

Another indicator of the suitable baking time is the peripheral hardness of the baked sweet potato. With baking, the sweet potato is softened significantly because of the partial breakdown of starch and cellular structures occurring when the baking heat is applied. The degree of firm to soft conversion is largely correlated with the extent of starch degradation by amylase. It is preferable for a baked sweet potato to be noticeably softer to the touch, but not so soft as to have become overly moist. As a rough indication, it has been found that a reduction in hardness to the point of being able to squeeze a thumb and index finger together through the sweet potato, with moderate resistance from the sweet potato, after baking corresponds to a sweet potato having a healthy-looking deep-orange flesh, that is suitably sweet, and that retains sufficient structure to be sliceable into the desired thicknesses without undue crumbling. Uniformity of structure is also desirable. If not baked enough, the flesh will be a lighter orange, and will be less uniform in colour. In this circumstance, the flesh of the undercooked sweet potato may be observed to have white patches where unconverted starch remains. Due to inconsistent starch conversion to maltose and dextrin the insufficiently baked sweet potato snack product will not have a uniform structure, and will therefore tend to crumble rather than exhibit a more chewy consistency. The chewy consistency in combination with the mashing enables the resultant snack product to be broken into discrete smaller pieces if desired, rather than crumbling or bending without snapping when breaking-off of smaller pieces is attempted. This aspect of the snack product can be very useful for animal owners that would like to provide their animal with smaller discrete pieces of snack product at a given serving.

During baking, the whole, raw, sweet potatoes are loaded onto trays to form a single layer per tray so that the periphery of the sweet potatoes will be substantially entirely exposed to the heat. Several loaded trays are placed on a cart, which is then rolled into an oven (step 110). Heat is then applied to the oven at a temperature and for a time as described above (step 120). With the baking completed, the cart is removed from the oven, and the baked sweet potatoes on their respective trays are permitted to cool somewhat (step 130).

Further detail of the forming of the thickened mash (step 200) is now provided. During this step the whole cooked potatoes are weighed and placed in an industrial mixer where the potatoes are mashed to a smooth, consistent texture. One or more additives may be added as binders to aid in thickening the mash. The additive may be added before or after the whole cooked potatoes are mashed to a smooth, consistent texture. The amount of additive added may vary depending on the variance in the moisture of the sweet potatoes after step 100.

It will be understood that various different additives could be used in the forming of the thickened mash. In one embodiment the additive is citrus fiber, which is preferred due to its simple, natural quality. The preferred amount of citrus fiber added relative to the amount of sweet potato has been found to be in the range of about 4:100 to about 6:100 by weight. Other possible additives include oatmeal, sweet potato flour, chick pea flour, white potato flour, and kelp.

A flavourant may also be added during step 200. For example, flavourants such as cranberries, cinnamon, kelp, salmon, chicken, and liver may be added. The flavourant(s) may be combined with the baked sweet potatoes before they are formed into a thickened mash, may be added during the thickening of the mash, or may be added to the thickened mash after it is formed.

With-the thickened mash having been formed, the thickened mash is then formed into segments (step 300). The segments are preferably formed by extrusion, using an appropriate extruder. Preferably the segments are formed into uniform, consistent shapes so that different snack product segments generally look alike. For example, in one embodiment the segments are each formed as strips having a thickness of about 0.125 inches to about 0.25 inches, a width of about 0.75 inches to about 1.25 inches, and a length of about 6 inches.

With the thickened mash having been formed into segments, the segments are then dried (step 400). Advantageously, drying is conducted in such a way so as to cause the segments to reach a moisture level of about 8% to about 20% as quickly as possible without burning the sugar in the segments by applying heat at too high a temperature. It has been found that drying the segments at a drying temperature below the burning point of the sugar, preferably about 165° F. to about 185° F. for about 5.5 hours to about 7.5 hours, and preferably about 6.5 hours, satisfactorily reduces the moisture to the desired range within an acceptable time frame without undue burning of the sugar.

FIG. 3 is a flow diagram showing further detail of the drying. The segments are loaded onto drying trays to form a single layer per tray so that the periphery of the segments will be substantially entirely exposed to the heat. Several loaded drying trays are placed on a cart, which is then rolled into an oven (step 410). Heat is then applied to the oven at a temperature and for a time as described above (step 420). Preferably air is moved within the oven to provide uniformity of heat throughout the drying process. With the drying completed, the cart is removed from the oven, and the dried segments on their respective trays are permitted to cool (step 430).

Although embodiments have been described with reference to the drawings, those of skill in the art will appreciate that variations and modifications may be made without departing from the spirit and scope thereof as defined by the appended claims.

For example, while particular dimensions of segments have been disclosed, and uniformity in segment dimensions is preferred, it will be appreciated that segments having different dimensions than those set forth above, and segments of varying lengths and sizes, are possible.

What is claimed is:

1. A process for making animal snack products, comprising:
baking at least one sweet potato to reach a conversion temperature for a time sufficient to generally uniformly convert starch in the at least one sweet potato to sugar;
forming a thickened mash from the at least one sweet potato;
forming segments from the thickened mash; and
applying heat at a drying temperature that is below the burning point of the sugar for a time sufficient to dry the segments to a threshold moisture level.

2. The process of claim 1, wherein the conversion temperature is about 170° F. to about 210° F.

3. The process of claim 1, wherein the conversion temperature is about 180° F. to about 200° F.

4. The process of claim 1, wherein the conversion temperature is about 190° F.

5. The process of claim 1, wherein the baking comprises baking the at least one sweet potato in an oven having a temperature of about 400° F. for about 90 minutes.

6. The process of claim 1, wherein during forming the thickened mash, the mash is formed and then thickened.

7. The process of claim 1, wherein during forming the thickened mash, the mash is thickened while being formed.

8. The process of claim 1, wherein during forming the thickened mash, the at least one sweet potato is combined with at least one additive.

9. The process of claim 8, wherein the at least one additive comprises citrus fibre.

10. The process of claim 9, wherein the ratio of citrus fibre to sweet potato is about 4:100 to about 6:100 by weight.

11. The process of claim 8, wherein the at least one additive comprises oatmeal.

12. The process of claim 11, wherein the at least one additive further comprises citrus fibre.

13. The process of claim 1, further comprising adding a flavourant.

14. The process of claim 13, wherein adding a flavourant occurs during the forming of the thickened mash.

15. The process of claim 13, wherein adding a flavourant occurs after the forming of the thickened mash.

16. The process of claim 13, wherein adding a flavourant occurs before the forming of the thickened mash.

17. The process of claim 1, wherein the segments formed from the thickened mash are generally rectangular in cross-section with a height of about 0.125 inches to about 0.25 inches before applying heat.

18. The process of claim 1, wherein the segments formed from the thickened mash are generally rectangular in cross-section with a width of about 0.75 inches to about 1.25 inches before applying heat.

19. The process of claim 1, wherein the segments formed from the thickened mash are generally rectangular in cross-section with a length of about 6 inches before applying heat.

20. The process of claim 1, wherein the threshold moisture level is about 8% to about 20%.

21. The process of claim 1, wherein the drying temperature is about 165° F. to about 185° F.

22. The process of claim 21, wherein the time sufficient to dry the segments to the threshold moisture level is about 5.5 hours to about 7.5 hours.

23. The process of claim 1, wherein the time sufficient to dry the segments to the threshold moisture level is about 6.5 hours.

24. The process of claim 1, further comprising:
during applying heat to the segments, causing air to flow about and around the segments.

25. The process of claim 1, wherein substantially all of the starch in the at least one sweet potato is converted to sugar.

26. A process for making animal snack products, comprising:
baking at least one sweet potato to reach an internal temperature of about 170° F. to about 210° F. for a time sufficient for the flesh in the sweet potato to significantly soften while retaining its structure;
forming a thickened mash from the at least one sweet potato;
forming segments from the thickened mash; and
applying heat at a drying temperature that is below the burning point of the sugar for a time sufficient to dry the segments to a threshold moisture level.

27. The process of claim 26, wherein the baking comprises baking at least one sweet potato to reach a desired hardness.

28. The process of claim 26, wherein the baking comprises baking at least one sweet potato to reach an internal temperature of about 190° F. for the sufficient time.

29. The process of claim 26, wherein the baking comprises baking the at least one sweet potato in an oven having a temperature of about 400° F. for about 90 minutes.

30. The process of claim 26, wherein during forming the thickened mash, the mash is formed and then thickened.

31. The process of claim 26, wherein during forming the thickened mash, the mash is thickened while being formed.

32. The process of claim 26, wherein during forming the thickened mash the at least one sweet potato is combined with at least one additive.

33. The process of claim 32, wherein the at least one additive comprises citrus fibre.

34. The process of claim 33, wherein the ratio of citrus fibre to sweet potato is about 4:100 to about 6:100 by weight.

35. The process of claim 32, wherein the at least one additive comprises oatmeal.

36. The process of claim 35, wherein the at least one additive further comprises citrus fibre.

37. The process of claim 26, further comprising adding a flavourant.

38. The process of claim 37, wherein adding a flavourant occurs during the forming of the thickened mash.

39. The process of claim 37, wherein adding a flavourant occurs after the forming of the thickened mash.

40. The process of claim 37, wherein adding a flavourant occurs before the forming of the thickened mash.

41. The process of claim 26, wherein the segments formed from the thickened mash are generally rectangular in cross-section with a height of about 0.125 inches to about 0.25 inches before applying heat.

42. The process of claim 26, wherein the segments formed from the thickened mash are generally rectangular in cross-section with a width of about 0.75 inches to about 1.25 inches before applying heat.

43. The process of claim 26, wherein the segments formed from the thickened mash are generally rectangular in cross-section with a length of about 6 inches before applying heat.

44. The process of claim 26, wherein the threshold moisture level is about 8% to about 20%.

45. The process of claim 26, wherein the drying temperature is about 165° F. to about 185° F.

46. The process of claim 45, wherein the time sufficient to dry the segments to the threshold moisture level is about 5.5 hours to about 7.5 hours.

47. The process of claim 26, wherein the time sufficient to dry the segments to the threshold moisture level is about 6.5 hours.

48. The process of claim 26, further comprising:
during applying heat to the segments, causing air to flow about and around the segments.

49. The process of claim 26, wherein substantially all of the starch in the at least one sweet potato is converted to sugar.

50. A process for making animal snack products, comprising:
baking at least one sweet potato to reach a conversion temperature for a time sufficient to generally uniformly convert starch in the at least one sweet potato to sugar while retaining sufficient structure in the at least one sweet potato;
forming a thickened mash from the at least one sweet potato;
forming segments from the thickened mash; and
applying heat at a drying temperature that is below the burning point of the sugar for a time sufficient to dry the segments to a threshold moisture level.

51. The process of claim 50, wherein the segments formed from the thickened mash are generally rectangular in cross-section, with a height of about 0.125 inches to about 0.25 inches before applying heat.

52. The process of claim 50, wherein the segments formed from the thickened mash are generally rectangular in cross-section, with a width of about 0.75 inches to about 1.25 inches before applying heat.

53. The process of claim 50, wherein the segments formed from the thickened mash are generally rectangular in cross-section, with a length of about 6 inches before applying heat.

52. The process of claim 50, wherein the threshold moisture level is about 8% to about 20%.

53. The process of claim 50, wherein during the baking substantially all of the starch in the at least one sweet potato is converted to sugar.

54. An animal snack product made by the process of claim 1.

55. An animal snack product made by the process of claim 26.

56. An animal snack product made by the process of claim 50.
